(19) United States
(12) Patent Application Publication
(10) Pub. No.: US 2026/0286965 A1
(43) Pub. Date: Sep. 24, 2026

(54) AXIAL FAN COMPRISING ENDPLATES AT THE TIP OF THE BLADES

(71) Applicant: R.E.M. PATENTS S.R.L., Arona (IT)

(72) Inventor: Roberto Eduardo MOSIEWICZ, Arona (IT)

(73) Assignee: R.E.M. PATENTS S.R.L., Arona, NO (IT)

(21) Appl. No.: 19/473,618

(22) PCT Filed: Apr. 9, 2024
(86) PCT No.: PCT/IB2024/053461

§ 371 Date: Oct. 8, 2025

(30) Foreign Application Priority Data
Apr. 11, 2023 (IT) 102023000006966

(51) Int. Cl. F04D 19/00; F04D 29/32; F04D 29/38; G05B 19/4097

(52) U.S. Cl. CPC F04D 19/002; F04D 29/325; F04D 29/384; G05B 19/4097; G05B 2219/35012

(57) ABSTRACT

An axial fan including a cylindrical casing, where each blade includes an aerodynamic portion that extends radially outwards, and an endplate at the outer tip; the aerodynamic portion is obtained from an extruded/pultruded profile and defines, in a cross section, an airfoil; the endplate extends in the axial direction and in the circumferential direction and has a cylindrical radially outer surface; when the endplate is correctly arranged adjacent to the casing, they define a gap with uniform and constant thickness. Further, the blade includes an interface between the aerodynamic portion and the endplate, where: the interface is structurally independent of the blade, the radially outer end of the aerodynamic portion is defined by a plane π; and the radially outer end of the interface adheres continuously to the endplate.

### TECHNICAL FIELD

The present invention refers to the sector of axial fans, in particular to the large-diameter axial fans for industrial use.

### BACKGROUND

In the sector of large-diameter axial fans 20 for industrial use, i.e. having a diameter greater than 90 cm (see for example FIG. 1), the use of extruded or pultruded profiles for the construction of the blades 26 is particularly widespread and appreciated. In the following, the word “profile” refers to the elongated semifinished product obtained by means of extrusion or pultrusion.

As is widely known, the extrusion process consists of forcing a ductile material (typically an aluminium alloy) through a die that reproduces the shape of the profile to be obtained. In the case of profiles intended for the construction of blades 26 of fan 20, the external shape is defined by an airfoil, while structural stiffening diaphragms can be arranged inside the profile (see FIG. 2). To simplify production, some airfoils with particularly extended chord (for example greater than 40 cm) can be made with two or more complementary profiles that must then be joined together along the longitudinal direction. For example, a first profile can make the front part of the airfoil (the one defining the leading edge) while a second profile makes the back part of the airfoil (the one defining the trailing edge). This process permits the industrial production of profiles with constant section having an indefinite a priori length along their longitudinal axis l.

A process conceptually similar to extrusion is pultrusion, used in the field of long-fibre composite materials. In this case, the reinforcement fibres and the matrix, in the unpolymerized state, are pulled through a heated die that gives the shape to the profile and at the same time induces the polymerization of the matrix. At the exit of the die we therefore have a profile with a constant section and an indefinite a priori length. Note that most of the fibres are as long as the profile itself and are arranged along its longitudinal axis l.

As briefly described above, both extrusion and pultrusion allow to make profiles having a constant section with indefinite a priori length. In addition, both these technologies guarantee a high quality of the outer surface of the profile, a characteristic that is particularly important in the field of fans 20 and aerodynamics in general. Still, both processes are characterised by relatively low production costs. For all these analogies, unless explicitly stated otherwise, in the discussion that follows the two processes and the resulting profiles will be considered completely overlappable on each other, provided that the extruded profiles are metallic (typically of aluminium) while the pultruded ones are made of composite material (typically epoxy matrix glass fibres).

The use of extruded/pultruded profiles has permitted a number of advantages, well known in the field of industrial fans 20, in terms of economy of production and flexibility of construction. In fact, the indefinite a priori length of the profiles allows them to be cut to size to obtain blades 26 with optimal length on a case-by-case basis. This allows the designer to freely define the diameter of the fan 20. In contrast, the dimensions of the blades 26 made by moulding are directly defined by the dimensions of the mould. In this case, the designer can therefore choose the diameter of the fan 20 only among the available sizes or, alternatively, must have a special mould made, thus causing an often unacceptable increase in costs.

As is known, the air flows that hit the ends of any aerodynamic surface, such as the blade 26 of a fan 20 during operation, are particularly complex. This phenomenon concerns both the radially inner end of the blade 26, and the radially outer end of the blade 26 (also called tip), with which the present invention is more directly connected.

Near the tip, the interruption of the blade 26 itself generates a displacement of air from the high pressure region (which is typically generated immediately downstream of the blade 26) towards the low pressure region (immediately upstream of the blade 26). This displacement adds to the main air flow, directed along the circumferential and axial directions, generating the known tip vortices.

The use of extruded/pultruded profiles has required some precautions, also in relation to the aerodynamic phenomena that take place at tip. Cutting the profile to the desired size exposes the inner cavities, making the interaction between the blade 26 and the swirling air flow present at the tip even more complex. Apart from the complexity of local phenomena, which makes precise modelling of the fan 20 difficult, the most obvious consequences at the macroscopic level are increased aerodynamic drag, increased noise, and decreased overall efficiency of the fan 20.

For this reason, the so-called cap 31 has been introduced, that is, an element that reproduces exactly the shape of the airfoil used in the blade 26 and that is shaped to be applied to the radially outer surface of the tip so as to cover the cavities of the profile and expose a continuous surface to the flow (see FIG. 2 in this regard).

The introduction of the cap 31 has also allowed a further advantage. Strictly speaking, the cut of the profile at the tip should be curved, that is, made along the cylindrical surface having the radius defined during the design phase for the fan 20. However, a cutting operation that, on an extruded/pultruded profile, must precisely follow a curved surface is not at all simple. For this reason, in order to simplify the construction of the blade 26, the curved cap 31 has been introduced (see FIG. 3). The curved cap 31 allows a straight cut to be made on the profile, i.e. a cut along a tangent plane instead of along the cylindrical surface. The function of restoring the curvature of the ideal design cylinder is carried out by the curved cap 31 itself. As can be appreciated from the schematic plan view of FIG. 3, the cap 31 has variable thickness and defines a (radially inner) flat surface that couples to the blade 26, and a (radially outer) curved surface that follows the ideal design curvature and, in the case of the ducted fans 20, approaches the casing 22. In this way the construction of the blade 26 is further simplified.

The adoption of the curved cap 31 in turn features again, although in a decidedly reduced way, the problem already emerged back in time with the blades 26 obtained by moulding. The curvatures available in the catalogue for the caps are in fact defined a priori, for example for some diameters among the most used in the industrial fans 20. In the event that the designer chooses a diameter that is not available, the blade 26 can be easily made, whereas the respective cap 31 must be chosen on the basis of an approximation, obtaining a sub-optimal solution. The adoption of a sub-optimal solution may represent a major problem in the case where the fan 20 is ducted, i.e. in the case where a cylindrical casing 22 is arranged around the fan 20 (see again FIG. 1). In this case the difference between the curvature of the cap 31 and the ideal (or design) curvature of the fan 20 is made particularly evident from the presence of the casing 22. In the example of FIG. 3, the tip of the blade 26 of a ducted fan 20 is represented in plan, on which a cap 31 having a more accentuated curvature is mounted, i.e. a cap 31 intended for a fan 20 with smaller diameter. As can be noted, the excessively accentuated curvature of the cap 31 implies a variable distance between the casing 22 and the cap 31 itself along the circumferential development of the tip. This configuration of the gap 34 that is formed between the tip and the casing 22 can also interact negatively with the tip air flow.

The problem can be solved by constructing an ad hoc, i.e. customized, curved cap 31 shaped according to the correct design curvature. Although the production of a customized cap 31 is decidedly simpler and cheaper than the production of the entire customized blade 26, this solution implies in any case an undesired increase in the complexity and costs of the production of the fan 20.

Still in the scope of the caps for the tips of the blades 26 obtained from extruded/pultruded profiles, it has recently been noted that considerable advantages derive from adding an endplate 32 that exceeds the shape of the airfoil and extends in the axial direction and, possibly, in the circumferential direction. Such endplates allow for example to limit the extension of the tip vortices or to exploit their presence and to reduce the noise generated by the flow at the tip. Other more specific advantages are related to the use of the endplates in combination with the casing 22. In this case the endplate 32 (or at least the radially outer surface thereof) must be shaped according to a cylinder portion having a slightly smaller radius than the casing 22, where the difference between the radii is defined during the design phase. In particular, the distance must be defined considering two partly conflicting requirements. On the one hand, the smaller the distance and the greater the benefits of the interaction between the endplate 32 and the casing 22. On the other hand, it is necessary to avoid that during normal operation of the fan 20 there may be contacts or scratchings between the endplate 32 and the casing 22.

Even the use of the endplates 32 at the tip, although interesting, did not achieve the desired results. In fact, the endplate 32 is defined based on the airfoil chosen for the blade 26 and, possibly, based on the diameter of the casing 22. Other design parameters of the fan 20, which are described below, are not considered in the definition of the endplate 32.

During the design phase, the same type of blade 26 can assume different angles of attack α, i.e. the blade 26 can be rotated around its longitudinal axis l to modify the forces generated in the interaction with the air flow. The endplate 32 follows the blade 26 in rotation, because it is integral therewith. FIG. 4 shows, in a view along the radial direction, the tip of a blade 26 with the respective endplate 32 and the casing 22 in the background. For clarity's sake, the generatrices straight lines of the cylinders are highlighted in FIG. 4, both on the cylinder of the casing 22 and on the cylinder of the endplate 32. As can be easily appreciated, instead of being perfectly coaxial, the two cylinders are rotated with respect to each other.

Moreover, in the design phase the same type of blade 26 can assume different precone angles β, i.e. the blade 26 can be rotated around its root so as to leave the rotation plane τ, i.e. the plane τ perpendicular to the rotation axis X (see FIG. 5). Also in this case, the endplate 32 follows the blade 26. FIG. 5 schematically shows a front view of the blade 26 with the respective endplate 32 and the adjacent casing 22. As can be easily appreciated, instead of being perfectly parallel to the casing 22, the endplate 32 is inclined by an angle equal to the precone angle β.

Finally, in the design phase the entire blade 26 or a radially outer portion thereof, can be rotated within its own rotation plane τ (forward or backward along the direction of rotation) so as to assume an angle called swing angle γ (see FIG. 6). Also in this case, the endplate 32 follows the blade 26. FIG. 6 schematically shows a plan view of the blade 26 with the respective endplate 32 and the adjacent casing 22. As can be easily appreciated, instead of being perfectly parallel and coaxial to the casing 22, the endplate 32 is inclined by an angle equal to the swing angle γ.

As can be clearly seen from the above description, each of the design parameters (i.e. the angle of attack α, the precone angle β and the swing angle γ) implies a misalignment between the endplate 32 and the respective casing 22. Each misalignment, by introducing a variable distance between the endplate 32 and the casing 22, implies a worsening of the aerodynamic phenomena that occur around the tip.

Therefore, the need for an improved axial fan is felt, which comprises an optimized endplate at the tip of the blades.

### OBJECTS AND SUMMARY OF THE INVENTION

An object of the present invention is therefore to overcome at least partially the drawbacks highlighted above in relation to the prior art.

In particular, a task of the present invention is to make available an axial fan that optimizes the geometry of the endplates at the tip of the blades.

Furthermore, a task of the present invention is to make available a ducted axial fan that optimizes the interaction between the endplates at the tip of the blades and the casing.

Moreover, a task of the present invention is to make available a method for improving the efficiency of an existing axial fan.

Finally, a task of the present invention is to make available a method for realizing an improved axial fan comprising optimized endplates at the ends of the blades.

These and other aims and tasks of the present invention are achieved by an axial fan and a method in accordance with the appended claims. Further features are identified in the dependent claims. All appended claims form an integral part of the present disclosure.

In accordance with a first aspect, the invention relates to an axial fan comprising a rotor rotatable about an axis of rotation X and a cylindrical casing arranged around the rotor and coaxial therewith. In the fan of the invention:
the rotor comprises a hub and a plurality of blades,
each blade comprises a radially inner root portion constrained to the hub, an aerodynamic portion that extends mainly radially from the root portion outwardly, and an endplate at the radially outer end,
the aerodynamic portion is obtained from an extruded/pultruded profile,
the aerodynamic portion defines, in a cross section, an airfoil,
the endplate extends mainly in the axial direction and in the circumferential direction,
the endplate defines a radially inner surface and a radially outer surface which is shaped according to a cylindrical surface portion, and
when the endplate is correctly arranged adjacent to the casing, the radially outer surface defines with the casing a gap with uniform and constant thickness.

The blade further comprises an interface positioned between the aerodynamic portion and the endplate, wherein:
the interface is made structurally independent of the aerodynamic portion of the blade;
the radially outer end of the aerodynamic portion is defined by a plane π;
the radially outer end of the interface adheres continuously to the radially inner surface of the endplate;
the radially inner end of the interface is defined by the plane π;
the radially inner end of the interface is coupled and connected continuously to the aerodynamic portion; and
the radially inner end of the interface comprises means for structural coupling with the radially outer end of the aerodynamic portion.

The provision of the interface allows to perfectly link the aerodynamic portion of the blade, whatever its orientation in space, to the endplate, whose position is strongly bound by the casing, in order to form a regular and uniform gap. In particular, manufacturing the interface as a structurally independent element allows extreme flexibility in working operations, in particular to cut the interface along the spatial curve representing the intersection between the blade and the radially inner surface of the endplate.

Preferably the thickness of the gap comprised between the endplate and the casing is less than or equal to 0.005 times the diameter of the fan.

This distance between the casing and the endplate allows to optimize the aerodynamic behaviour of the tip of the blade, avoiding at the same time the risk of undesired contacts between the endplate and the casing during the operation of the fan.

Preferably the interface is joined to the aerodynamic portion of the blade during the assembly of the fan.

The joining of the interface during the assembly of the fan guarantees a high manufacture flexibility and improved handling of the components from the production site to the final assembly site of the fan.

Preferably the endplate is obtained by at least a first panel, radially innermost, and a second panel, radially outermost, juxtaposed with each other in radial direction.

The provision of two panels makes it possible to obtain high manufacture flexibility in the face of improved mechanical characteristics for the endplate.

According to some embodiments, the casing comprises an annular seat which circumferentially extends around the rotor and opens in the axial direction. Advantageously each of the endplates provided at the end of the blades is at least partially received in the annular seat. Preferably on the interface a baffle is provided which extends in the circumferential and axial directions, radially inside with respect to the endplate and to the annular seat.

Such embodiments exploit a solution, developed by the same Applicant, which allows to obtain a sort of labyrinth seal between the blade and the casing. The seal prevents in a very effective manner air to flow around the tip of the blade. The presence of the baffle allows to further improve effectiveness of the solution.

In accordance with a second aspect, the invention relates to an industrial cooling system comprising a fan according to what is described above.

The use of the fan within an industrial cooling system allows to exploit the advantageous features of the invention at their maximum.

In accordance with a third aspect, the invention relates to a method for modifying an existing axial fan comprising a hub rotatable about an axis of rotation X, a plurality of blades and a cylindrical casing arranged around the hub and coaxial therewith, wherein each blade comprises an aerodynamic portion obtained from an extruded/pultruded profile having its own longitudinal axis l and having a cross section, perpendicular to the longitudinal axis l, shaped according to an airfoil. The method of the invention first comprises the step of defining an endplate based on the diameter of the casing, and wherein the endplate:
extends mainly in the axial direction and in the circumferential direction,
defines a radially inner surface and a radially outer surface which is shaped according to a cylindrical surface portion, and
when the endplate is correctly arranged adjacent to the casing, the radially outer surface defines with the casing a gap with uniform and constant thickness.

The method further comprises the steps of:
identifying the airfoil with which the aerodynamic portion of the blades is made;
identifying the geometric design parameters of the blades of the rotor, i.e.: angle of attack α, precone angle β and swing angle γ;
defining a virtual blade having the airfoil and the geometric design parameters identified above and an indefinite radial extension;
determining the spatial curve representing the intersection between the virtual blade and the radially inner surface of the endplate when the endplate is correctly arranged adjacent to the casing;
providing an interface having a radially inner end that defines a rest plane π and shaped to couple and connect continuously to the radially outer end of the extruded/pultruded profile of the blade;
cutting the radially outer end of the interface along the intersection spatial curve;
constraining the radially outer end of the interface to the radially inner surface of the endplate;
cutting the blade along the rest plane π;
constraining the radially inner end of the interface to the radially outer end of the aerodynamic portion of the cut blade; and
repeating the operations defined above for each blade.

This method allows to apply the invention to existing fans, so as to achieve great benefits with a cost limited only to the modification of the tip of the blades. In accordance with a fourth aspect, the invention relates to a method for making from the beginning an axial fan comprising a hub rotatable about an axis of rotation X, a plurality of blades and a cylindrical casing arranged around the hub and coaxial therewith. The method of the invention comprises the steps of:
defining the diameter of the casing
based on the diameter of the casing, defining an endplate, wherein the endplate:
   extends mainly in the axial direction and in the circumferential direction,
   defines a radially inner surface and a radially outer surface which is shaped according to a cylindrical surface portion,
   when the endplate is correctly arranged adjacent to the casing, the radially outer surface defines with the casing a gap with uniform and constant thickness;
selecting the airfoil with which to make the aerodynamic portion of the blades;
providing an extruded/pultruded profile having the airfoil selected above and an indefinite extension along its own longitudinal axis l perpendicular to the airfoil plane;
providing a root portion at a radially inner end of the extruded or pultruded profile;
defining the geometric design parameters of the blades of the rotor, i.e.: angle of attack α, precone angle β and swing angle γ;
defining a virtual blade having the airfoil selected above, the geometric design parameters defined above and an indefinite radial extension;
determining the spatial curve representing the intersection between the virtual blade and the radially inner surface of the endplate when the endplate is correctly arranged adjacent to the casing;
providing an interface having a radially inner end that defines a rest plane π and shaped to couple and connect continuously to the radially outer end of the extruded/pultruded profile of the blade;
cutting the radially outer end of the interface along the intersection spatial curve;
constraining the radially outer end of the interface to the radially inner surface of the endplate;
cutting the extruded/pultruded profile of the blade along the rest plane π, so as to obtain the aerodynamic portion;
constraining the radially inner end of the interface to the radially outer end of the aerodynamic portion;
constraining the root portion of the blade to the hub according to the geometric design parameters;
repeating the operations defined above for each blade.

This method allows to apply the invention to brand new fans, so as to make the most of all its advantages.

Preferably, in either of the methods described above, at least some of the steps of the process are carried out with the aid of a computer system of CAD/CAM type.

Preferably, the step of cutting the radially outer end of the interface along the intersection spatial curve is carried out by means of a numerical control machine.

The use of a computer system of CAD/CAM type, and in particular of a numerical control machine for cutting the interface along the intersection spatial curve, allows to remarkably simplify the implementation of the method of the invention.

Further features and aims of the present invention will be more evident from the following description.

### BRIEF DESCRIPTION OF THE DRAWINGS

The invention is described hereinbelow with reference to some examples provided by way of non-limiting example and illustrated in the accompanying drawings. These drawings illustrate different aspects and embodiments of the present invention and components, materials and/or similar elements in different figures are indicated by similar reference numerals, where appropriate. Moreover, for clarity of illustration, some references may not be repeated in all figures.

FIG. 1 is an axonometric view of a ducted axial fan for industrial use;

FIG. 2 is an exploded axonometric schematic view of the radially outer end of a blade of a fan in accordance with the prior art;

FIG. 3 is a schematic plan view of the radially outer end of a blade of a ducted fan in accordance with the prior art;

FIG. 4 is a schematic view along the radial direction of a blade of a ducted fan in accordance with the prior art;

FIG. 5 is a schematic front view of the radially outer end of a blade of a ducted fan in accordance with the prior art;

FIG. 6 is a schematic plan view of the radially outer end of a blade of a ducted fan in accordance with the prior art;

FIG. 7 is a schematic axonometric view showing the blade of a fan in accordance with the invention, wherein some parts of the fan have been deleted for clarity's sake;

FIG. 8 is a schematic plan view of the tip of a blade in accordance with the invention;

FIG. 9 is a schematic plan view of the tip of another blade in accordance with the invention;

FIG. 10 is a schematic plan view of the tip of a further blade in accordance with the invention;

FIG. 11.a is a schematic plan view of the tip of a blade being processed, in accordance with the invention;

FIG. 11.b is a schematic front view of the tip of a blade being processed, in accordance with the invention;

FIGS. 12 and 13 schematically show two steps of the method in accordance with the invention;

FIG. 14 is a schematic axonometric view of a semi-finished interface employed in the method in accordance with the invention;

FIG. 15 is a schematic exploded front view of the tip of a blade in accordance with the invention;

FIG. 16 is a schematic plan view of the tip of FIG. 15;

FIG. 17 is a schematic axonometric view of the tip of FIG. 15; and

FIG. 18 is a schematic axonometric view of the tip of a blade in accordance with an embodiment of the invention;

FIG. 19 is a view, similar to the one of FIG. 18, of a blade in accordance with another embodiment of the invention;

FIG. 20 is a schematic front view of the tip of a blade in accordance with another embodiment of the invention;

FIG. 21 is a schematic plan view of the tip of the blade of FIG. 20;

FIG. 22 is a schematic axonometric exploded view of the tip of another blade in accordance with the invention; and

FIG. 23 is a schematic plan view of the tip of the blade of FIG. 22.

### DETAILED DESCRIPTION OF THE INVENTION

While the invention is susceptible to various modifications and alternative constructions, some preferred embodiments are shown in the drawings and are described hereinbelow in detail. It must in any case be understood that there is no intention to limit the invention to the specific embodiment illustrated, but, on the contrary, the invention intends covering all the modifications, alternative and equivalent constructions that fall within the scope of the invention as defined in the claims.

The description deals in detail with the peculiar aspects and the technical characteristics of the invention, while the aspects and the technical characteristics per se known can only be hinted at. Regarding these aspects, the foregoing reported with reference to the prior art remains valid.

The use of “for example”, “etc.”, “or” refers to non-exclusive non-limiting alternatives, unless otherwise stated. The use of “comprises” and “includes” means “comprises or includes, but not limited to”, unless otherwise indicated.

In the discussion that follows, the term “airfoil” generally indicates a shape, in itself well known to the person skilled in the art, suitable for interacting with a fluid flow for the purpose of exchanging forces. The shape used in the invention is usually intended to interact with air, therefore it is also called “airfoil”, without thereby introducing any limitation to the interaction with gases other than air.

The term “airfoil” can take on two slightly different meanings. A first meaning is virtual and indicates the curve that is graphically drawn on a plane or is defined in digital form for the purpose of studying the realization of a real device. A second meaning is practical and indicates the material shape that, in cross section, reproduces the virtual airfoil. If it is necessary to distinguish the two meanings, the first one can also be referred to as the “virtual airfoil” and the second one as the “real airfoil”.

Similar to the term “airfoil”, also other terms indicating elements of the fan of the invention (such as “casing”, “blade”, “endplate”, etc.) may take on two slightly different meanings. The first meaning is virtual and indicates the geometric or digital representation used for the study and the realization of a real device. A second meaning is practical and indicates the physical, material element. If it is necessary to distinguish the two meanings, the first one can also be indicated with the adjective “virtual” and the second one with the adjective “real”. In any case, the person skilled in the art has no difficulty in transposing the considerations and the assessments from the abstract or digital geometric field to the physical and real field.

In the following description, reference is often made to geometric concepts (parallel, perpendicular, coaxial, etc.) and to geometric entities (plane, axis, cylinder, etc.). As the person skilled in the art can well understand, such expressions are not to be understood in the abstract and perfect sense of pure geometry, but they are to be interpreted in relation to the technical scope of the invention and the typical tolerances of the field.

The following discussion concerns an industrial axial fan that uniquely defines an axis of rotation X with respect to which the terms “axial”, “radial”, “circumferential” and “tangential” are uniquely defined.

In particular, the axial direction (sometimes indicated in the drawings with a) is the direction of any straight line parallel to the axis X; the radial direction (sometimes indicated in the drawings with r) is the direction of any half straight line originating on the axis X and perpendicular thereto; the circumferential direction (sometimes indicated in the drawings with c) is the direction of any circumference with centre on the axis X and lying on a plane perpendicular thereto; finally, the tangential direction (sometimes indicated in the drawings with t) is the direction of any straight line tangent to one of the circumferences just defined.

In the following description, reference is often made to the “longitudinal axis l”. Such longitudinal axis l is unambiguously defined for each profile, since it directly derives from the extrusion/pultrusion direction. Although the same longitudinal axis l is sometimes (improperly) referred to the blade 26 or to its aerodynamic portion 30, the skilled person will have no difficulty in identifying it correctly based on the context.

In accordance with a first aspect, the invention relates to an axial fan 20 comprising a rotor rotatable about an axis of rotation X and a cylindrical casing 22 arranged around the rotor and coaxial therewith. In the fan 20 of the invention:
the rotor comprises a hub 24 and a plurality of blades 26,
each blade 26 comprises a radially inner root portion 28 constrained to the hub 24, an aerodynamic portion 30 that extends mainly radially from the root portion 28 outwardly, and an endplate 32 at the radially outer end,
the aerodynamic portion 30 is obtained from an extruded/pultruded profile
the aerodynamic portion 30 defines, in a cross section, an airfoil
the endplate 32 extends mainly in the axial direction and in the circumferential direction
the endplate 32 defines a radially inner surface and a radially outer surface which is shaped according to a cylindrical surface portion
when the endplate 32 is correctly arranged adjacent to the casing 22, the radially outer surface defines with the casing 22 a gap 34 with uniform and constant thickness,
and wherein the blade 26 further comprises an interface 36 positioned between the aerodynamic portion 30 and the endplate 32,
the interface 36 is made structurally independent of the aerodynamic portion 30 of the blade 26;
the radially outer end of the aerodynamic portion 30 is defined by a plane π;
the radially outer end of the interface 36 adheres continuously to the radially inner surface of the endplate 32;
the radially inner end of the interface 36 is defined by the plane π;
the radially inner end of the interface 36 is coupled and connected continuously to the aerodynamic portion 30; and
the radially inner end of the interface 36 comprises means 40 for structural coupling with the radially outer end of the aerodynamic portion 30.

The fan 20 of the invention is described in more detail below with reference to the attached figures. The fan 20 of the invention is large in diameter, i.e. has a diameter greater than 90 cm, preferably greater than 150 cm.

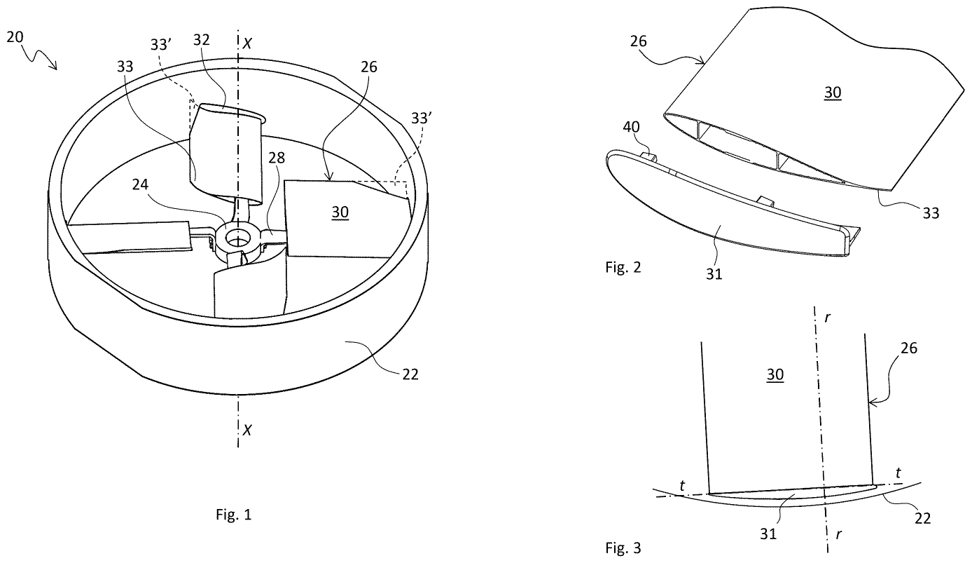

In the attached figures, with the only exception of FIG. 1, only one of the n blades 26 of the fan 20 is shown for clarity's sake, and the casing 22 is only partially represented so as not to hide other parts that must be visible.

The root portion 28, in itself well known, has the exclusively structural function of connecting the blade 26 to the hub 24 and of ensuring that, during normal operation of the fan 20, it keeps the position defined during the design phase, especially in terms of angle of attack α, precone angle β and swing angle γ.

Preferably the root portion 28 is configured in such a way as to assume a predefined deformability, such as to facilitate in the blade 26 a prevailing vibration of the second order which, with respect to the vibration of the first order, significantly limits the amount of translation of the tip in the axial direction. A solution of this type is described in WO 2017/063712 on behalf of the same Applicant.

The aerodynamic portion 30 of the blade 26 is the one that is intended to interact most with the air flow in order to exchange forces and, ultimately, create an air flow in the axial direction. For this reason, the aerodynamic portion 30 simultaneously performs an aerodynamic function (in generating forces through interaction with the flow) and a structural function (in transmitting and counteracting the forces it generates). The aerodynamic portion 30 is obtained from an extruded/pultruded profile, shaped according to an airfoil.

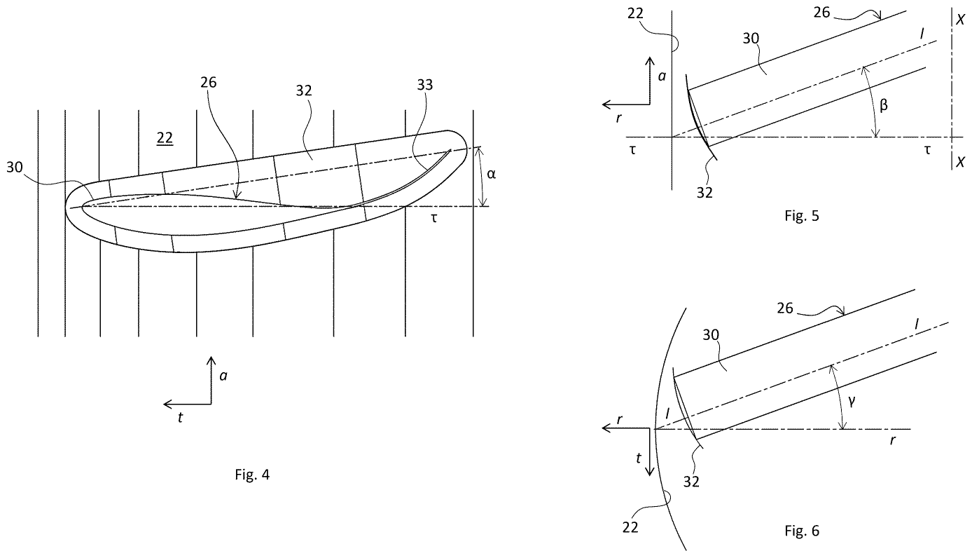

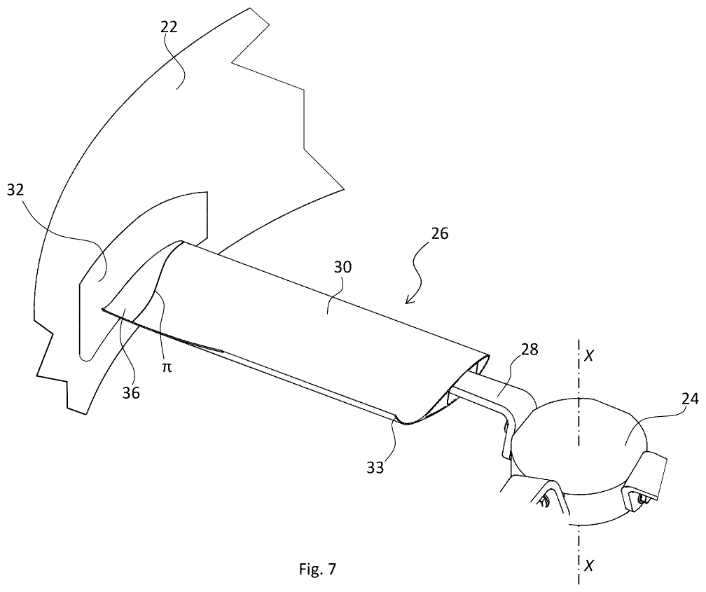

Preferably, in manufacturing the aerodynamic portion 30 of the blade 26, a technique is adopted, known per se, called trimming which allows to obtain a variation in the cross section of the extruded/pultruded profile. Such technique is adopted with extruded/pultruded profiles in which the dorsal wall and the ventral wall join in one rear monolithic appendix 33 (see in particular FIGS. 2 and 4). Such monolithic appendix 33 extends rearwardly, usually with a quite pronounced curvature, up to the trailing edge. The trimming, which allows to obtain an extruded/pultruded aerodynamic portion 30 having a variable airfoil along the longitudinal axis l, is briefly disclosed in the following with reference to FIG. 1.

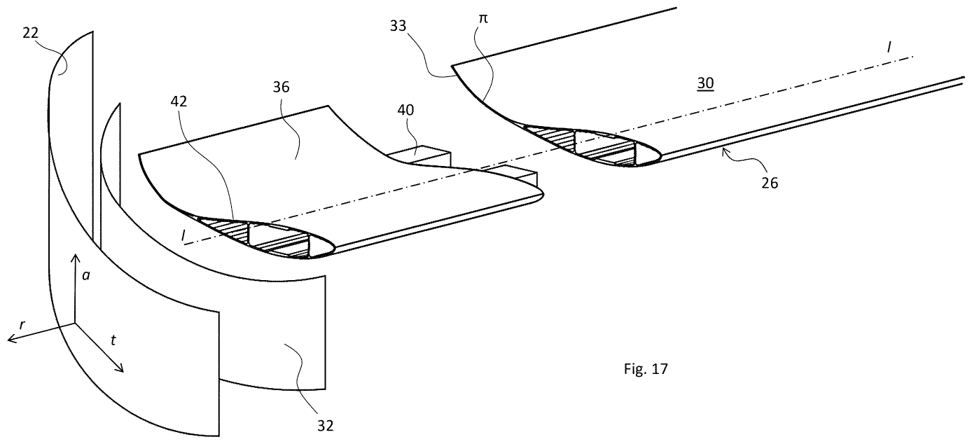

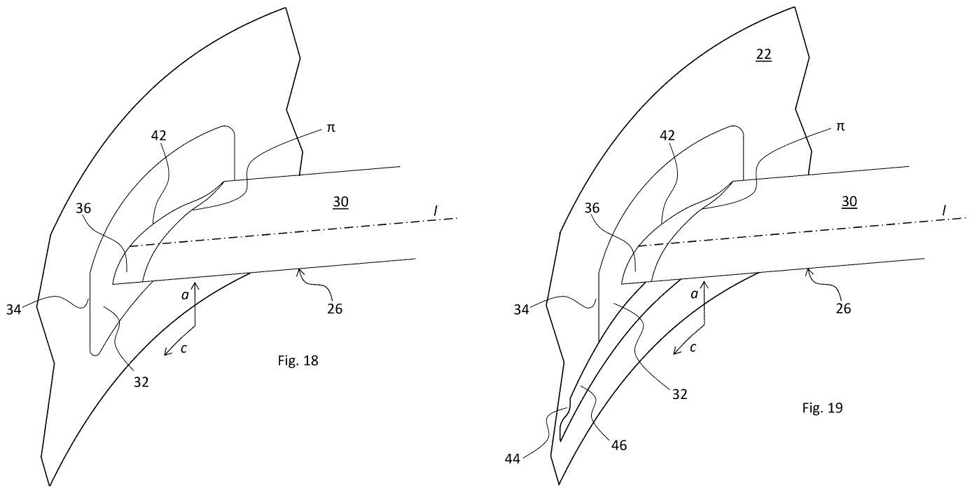

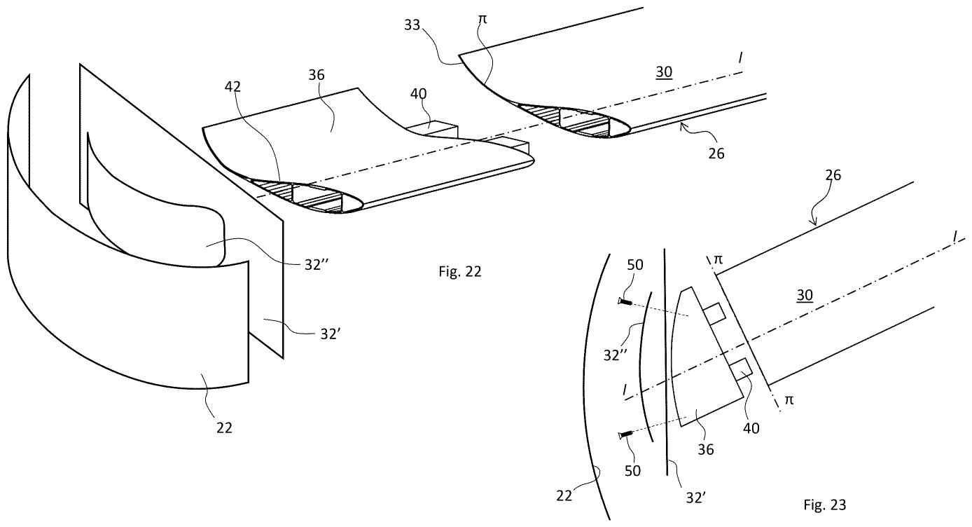

In the blade 26 of FIGS. 17 and 22, the aerodynamic portion 30 extends radially with a constant cross section. Conversely, in the solution of FIG. 1 the trimming has been used: appendix 33 has been progressively reduced in the radially outer region of the aerodynamic portion 30. In FIG. 1 the portions of the appendix 33 which have been removed are shown in dashed lines and referenced to as 33′. Trimming allows to obtain a greater aerodynamic efficiency because, along the blade 26, it progressively reduces both the attack angle α and the curvature of the airfoils in the radially outer region where the fluid flow reaches the highest speed.

The radially outer end of the aerodynamic portion 30 is defined by a plane π, i.e. the aerodynamic portion 30 is cut along a plane, preferably transverse to the longitudinal axis l of the blade 26.

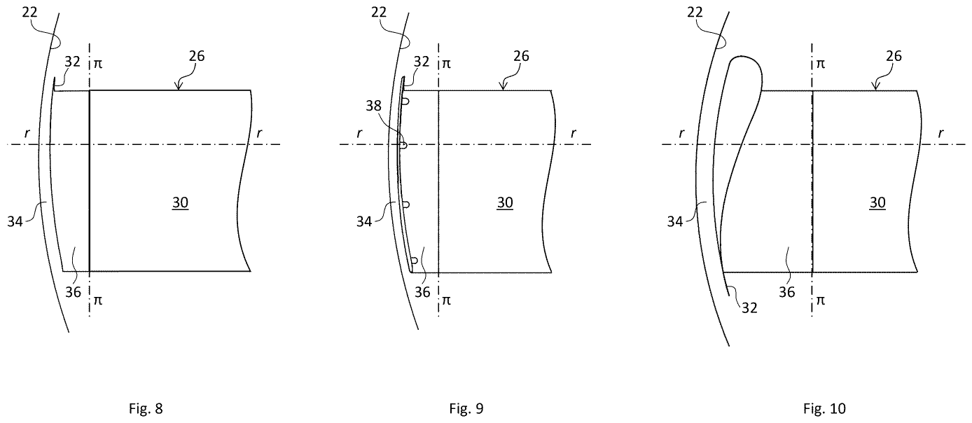

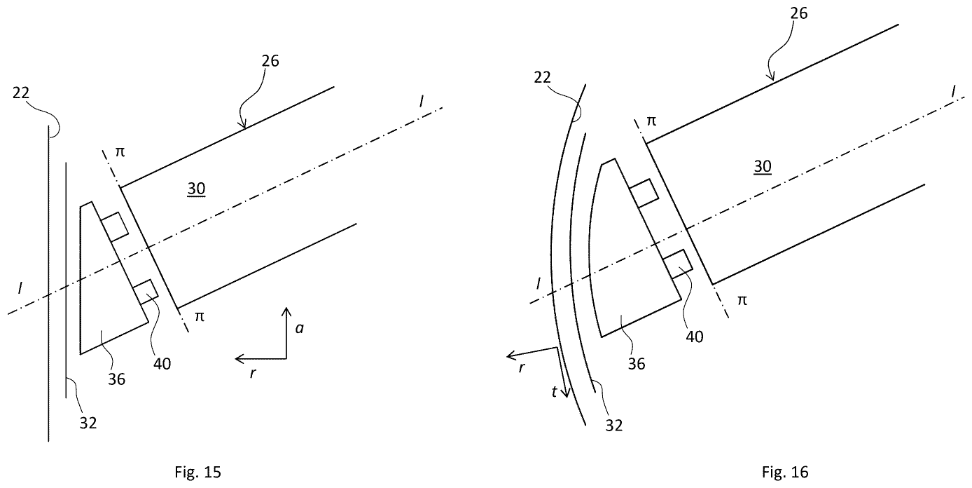

In accordance with some embodiments (for example those of FIGS. 8 and 15-17), the endplate 32 is obtained from a simple flat layer of material (such as for example a sheet of sheet metal or a thin composite panel), cut to size and curved according to a portion of cylindrical surface that follows the casing 22 remaining at a uniform and constant distance therefrom. In this case, since the endplate 32 has constant thickness, the radially outer surface and the radially inner surface are both cylindrical. These are the simplest embodiments of the endplate 32.

In accordance with other embodiments (e.g. that of FIG. 9), the endplate 32 comprises ribs 38 arranged along the axial direction, i.e. along the generatrices of its cylinder. This embodiment, although not aerodynamically optimal, makes it possible to considerably limit the deformations in the radial direction to which the axial ends of the endplate 32 are subjected. Such deformations, in fact, mainly due to the centrifugal force acting on the endplate 32 during normal operation of the fan 20, significantly increase with increasing axial extension of the endplate 32. In some cases, the benefits deriving from the axial extension of the endplate 32 may compensate for the disadvantages deriving from the ribs 38 present on the radially inner surface of endplate 32.

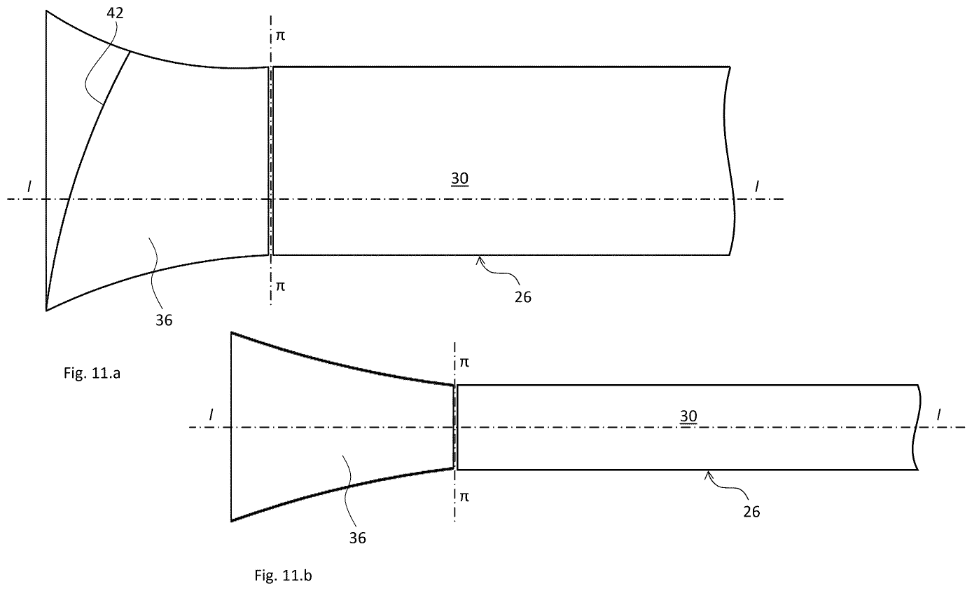

Finally, in accordance with other embodiments (for example the one of FIG. 10), the endplate 32 has a complex section, for example it in turn assumes an airfoil. This embodiment is the most complex one but allows to provide ribs 38 in axial direction to limit the deformations deriving from the centrifugal force and, at the same time, to embed the ribs 38 in the thickness of the airfoil so as to eliminate the aerodynamic disturbances.

In view of the foregoing, it will be clear to the person skilled in the art that, while the radially outer surface of the endplate 32 is always a cylindrical surface, because it must closely follow the radially inner surface of the casing 22, the radially inner surface of the endplate 32 may assume different shapes. In general, the radially inner surface of the endplate 32 will not be flat and will therefore not be able to connect directly to the radially outer end of the aerodynamic portion 30, which is defined by the plane π.

The distance between the casing 22 and the endplate 32, i.e. the uniform and constant thickness of the gap 34, must be defined during the design phase considering two partially contrasting needs. On the one hand, the smaller the distance and the greater the benefits of the aerodynamic interaction between the endplate 32 and the casing 22. On the other hand, it is necessary to avoid that during normal operation of the fan 20 there may be contacts or scratchings between the endplate 32 and the casing 22. Preferably said distance is less than or equal to 0.005 times the diameter of the fan.

In the fan 20 of the invention, the blade 26 comprises an interface 36 positioned between the aerodynamic portion 30 and the endplate 32. The interface 36 is an element that is made structurally independent of the aerodynamic portion 30 of the blade 26 and that, preferably, is joined to the latter only during assembly of the fan 20.

As mentioned above, the radially outer end of the interface 36 is configured to adhere continuously to the radially inner surface of the endplate 32. One possible method for conforming the radially outer end of the interface 36 so that it adheres continuously to the radially inner surface of the endplate 32 is described below. On that occasion, the semi-finished product from which the interface 36 is made is also described.

The radially inner end of the interface 36 is defined by the plane π and this allows the radially inner end of the interface 36 to be firmly rested at the radially outer end of the aerodynamic portion 30. Preferably, the radially inner end of the interface 36 is shaped according to the same airfoil as the aerodynamic portion 30. This allows the two parts to be perfectly and continuously coupled and connected, so as to guarantee excellent aerodynamic performance of the joint.

In accordance with some embodiments, the interface 36 has constant section along its development in the radial direction, between the aerodynamic portion 30 and the endplate 32. In accordance with other embodiments (e.g. see FIG. 11), the interface 36 has variable cross section along its development in the radial direction; in the radial direction, from the aerodynamic portion 30 to the endplate 32, the interface 36 may have increasing chord (see FIG. 11.a) and/or the interface 36 may have increasing thickness (see FIG. 11.b).

The variation of the cross section of the interface 36 along its radial development, whether in chord and/or thickness, can lead to a reduction in the noise generated by the fan 20 during its operation. As a matter of fact, as can be appreciated from FIG. 11.a and 11.b, such variation of the cross section of the interface 36 allows to smoothly direct the share of the air flow which travels along the blade 26 in the radial direction under the effect of centrifugal force, thus preventing such air flow from perpendicularly hitting against the endplate 32 an/or against the casing 22.

The radially inner end of the interface 36, in addition to defining a rest plane intended to coincide with the plane π, also comprises means 40 for the structural coupling with the radially outer end of the aerodynamic portion 30. By way of example, the structural coupling means 40 may comprise inner protrusions, intended to be inserted along the radial direction into the cavities defined by the extruded/pultruded profile of the aerodynamic portion 30 (see FIG. 14). Such coupling means 40 allow to maintain the external shape of the airfoil almost unchanged, minimizing aerodynamic disturbances. In other embodiments, the structural coupling means 40 may comprise outer protrusions, intended to partially overlap the extruded/pultruded profile of the aerodynamic portion 30. In accordance with other embodiments, the coupling means 40 may comprise other solutions known in the art such as for example screws, joints, glues or welds.

Thanks to the precision in the assembly, the use of the interface 36 of the invention allows to obtain a particularly efficient cooperation between the endplate 32 and the casing 22. This possibility can be exploited in a particularly advantageous manner by applying the present invention to the solution disclosed in the patent application WO 2020/245674, in the name of the same Applicant. According to such known solution, the casing 22 comprises an annular seat 44 which extends circumferentially around the rotor of the fan 20. The annular seat 44 opens in the axial direction a; preferably it is obtained by applying inside the casing 22 a converging smoothing surface 46 immediately upstream of the rotor. Each of the endplates 32 provided at the end of the blades 26, extends in the axial direction a and in the circumferential direction c, and is received at least partially in the annular seat 44 of the casing 22. Such solution is schematically shown in FIG. 19.

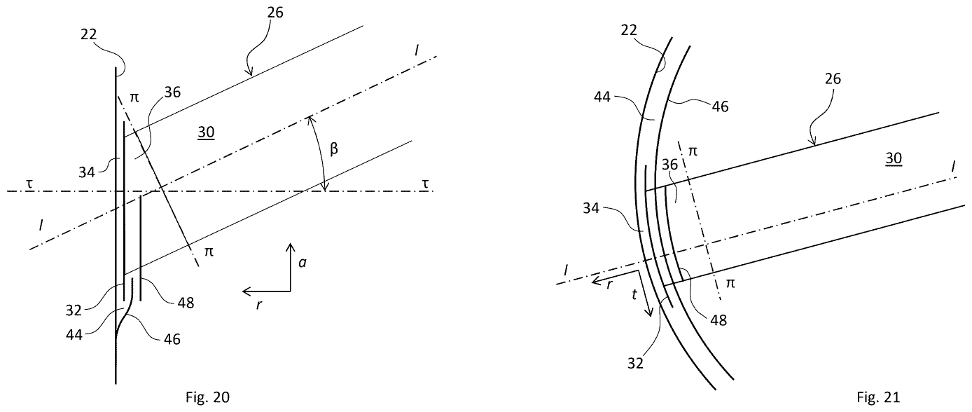

The embodiment of FIG. 19 wherein the endplate 32 is received in the annular seat 44 can be further improved by adding a baffle 48 which extends in the circumferential direction c and in the axial direction a and which is provided on the interface 36, radially inside with respect to the endplate 32 and with respect to the annular seat 44. In particular, the baffle 48 is provided on the interface 36, radially inside with respect to the converging smoothing surface 46. An embodiment of the invention which comprises the baffle 48 is schematically shown in FIGS. 20 and 21. As the skilled person can appreciate from FIG. 21, the casing 22, the endplate 32, the edge of the converging smoothing surface 46 and the baffle 48 all develop on concentric cylindrical surfaces having progressively decreasing diameters, in the reported order.

FIG. 20 schematically shows a front view of the tip of a blade 26 comprising an endplate 32 and a baffle 48, both fixed on the interface 36. As can be seen in FIG. 20, between the casing 22 and the endplate 32 the gab 34 is defined. Moreover, the converging smoothing surface 46 forms the annular seat 44 inside which the endplate 32 extends in the axial direction. Lastly, the baffle 48 is in turn adjoined to the converging smoothing surface 46, remaining at a predefined distance, for example at a distance similar to the thickness of the gap 34.

Preferably, as can be appreciated in the embodiment of FIG. 20, the baffle 48 extends in the axial direction only upstream of the rotor (i.e. downwards, in FIG. 20) differently from the endplate 32 which extends in axial direction both upstream and downstream of the rotor.

FIG. 21 schematically shows a plan view of the tip of a blade 26 similar to the one of FIG. 20. Such blade 26 comprises an endplate 32 and a baffle 48, both fixed on the interface 36. As in FIG. 20, also in FIG. 21 between the casing 22 and the endplate 32 gap 34 is defined. Moreover, the converging smoothing surface 46 forms the annular seat 44 inside which the endplate 32 is received. Lastly, the baffle 48 is adjoined to the converging smoothing surface 46, remaining at a predefined distance.

In a manner known per se from patent application WO 2020/245674, the co-operation between the casing 22, the endplate 32 and the annular seat 44 defined by the converging smoothing surface 46 define a sort of labyrinth seal. The fact that the endplate 32 enters in the annular seat 44 in the axial direction defines an obstacle for recirculation of air around the tip, since such recirculation requires to air itself to reverse flow direction twice.

Such effect of labyrinth seal is further improved by the presence of the baffle 48, placed radially inside with respect to the annular seat 44. The skilled person can appreciate such solution in particular from FIG. 20, where fixed elements (i.e. the casing 22 and the converging smoothing surface 46) are alternated with rotating elements (i.e. the endplate 32 and the baffle 48) so as to form a particularly marked labyrinth. The tortuous path defined by the labyrinth represents a hindrance for passage of air around the tip of the blade 26, since along such path air should repeatedly reverse its own direction.

In accordance with some embodiments (for example that of FIGS. 22 and 23), the endplate 32 is obtained by at least two panels, juxtaposed in radial direction. In such a case, a first, radially innermost panel 32′ may consist of a flat sheet (for example of sheet metal or composite), simply cut to size. The second panel 32″, radially outermost, may instead be curved according to a cylindrical surface portion that follows the casing 22. In this case, the first panel 32′ defines the dimensions of the endplate 32 (in particular in the axial and circumferential directions), while the second panel 32″ defines the curvature thereof, forcing the first panel 32′ against the interface 36.

This embodiment allows small adjustments to be made to the position of the endplate 32, during assembly, for example by rotating the first panel 32′ with respect to the casing 22 within a range of few degrees in order to correct any small errors. For this purpose, the first panel 32′ and the second panel 32″ can be constrained to the interface 36 by means of mounting screws 50 (see FIG. 23) that pass through them both. In this case, the second panel 32″, whose position with respect to the interface 36 is unique, may preferably comprise circular holes, each of which in turn uniquely defines the position of the relative mounting screw 50. Otherwise, the first panel 32′ may preferably comprise elongated slots that, during assembly, allow a small freedom of movement to the first panel 32′ itself with respect to the interface 36 and the casing 22.

The provision of two panels 32′ and 32″ can also give to the endplate 32 as a whole improved mechanical characteristics, for example to counteract the centrifugal force that tends to move the free ends of the endplate 32 itself away radially outwards, i.e. the furthest ends (typically in the axial direction, but also in the circumferential direction) from the constraints. More particularly, the shape and material with which the second panel 32″ is made can be defined to provide a structural support to the first panel 32′, counteracting the deformation thereof due to centrifugal force.

In the event that the endplate 32 is obtained by juxtaposing two panels 32′ and 32″ in the radial direction, the gap 34 of uniform and constant thickness is comprised between the casing 22 and the radially outer surface of the second panel 32″. Strictly speaking, therefore, the gap 34 of uniform and constant thickness has a smaller extension than the endplate 32 as a whole. However, in some embodiments, the thickness of the second panel 32″ can be considered negligible with respect to the thickness of the gap 34, such that the thickness of the gap 34 can be considered uniform and constant throughout the extension between the casing 22 and the radially outer surface of the first panel 32′.

In accordance with a second aspect, the invention relates to an industrial cooling system (not shown) comprising a fan 20 according to what is described above.

The cooling system of the invention is typically a system intended to disperse heat produced by an industrial process. For example, the fan 20 can be comprised in a cooling tower intended for the dissipation of heat generated by a large HVAC system (Heating Ventilation and Air Conditioning), by a power generation plant, by a refinery, by a petrochemical plant or the like.

In accordance with other aspects, the invention concerns methods for obtaining a fan 20 in accordance with the foregoing.

A first method of the invention is intended to modify an existing ducted fan 20 to improve its performance in the context of a revamping intervention of the plant.

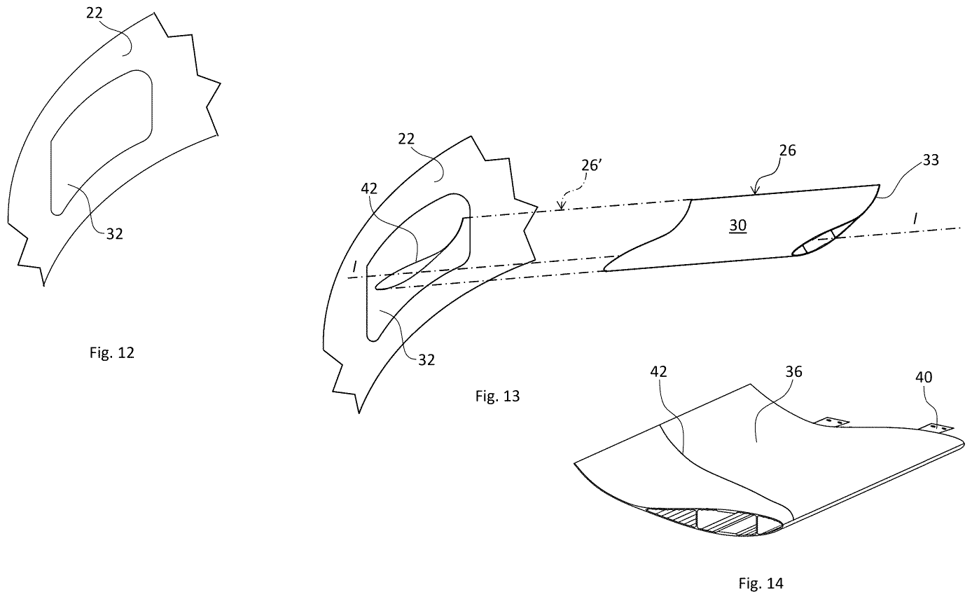

The existing axial fan 20 comprises a hub 24 rotatable about an axis of rotation X, a plurality of blades 26 and a cylindrical casing 22 arranged around the hub 24 and coaxial therewith, wherein each blade 26 comprises an aerodynamic portion 30 obtained from an extruded/pultruded profile having its own longitudinal axis l and having a cross section, perpendicular to the longitudinal axis l, shaped according to an airfoil. The method of the invention comprises the steps of:
based on the diameter of the casing 22, defining an endplate 32 (see FIG. 12), wherein the endplate 32:
   extends mainly in the axial direction and in the circumferential direction,
   defines a radially inner surface and a radially outer surface which is shaped according to a cylindrical surface portion,
   when the endplate 32 is correctly arranged adjacent to the casing 22, the radially outer surface defines with the casing 22 a gap 34 with uniform and constant thickness;
identifying the airfoil with which the aerodynamic portion 30 of the blades 26 is made;
identifying the geometric design parameters of the blades of the rotor 26, i.e.: angle of attack α, precone angle β and swing angle γ;
defining a virtual blade 26′ having the airfoil and the geometric design parameters identified above and an indefinite radial extension;
determining the spatial curve 42 representing the intersection between the virtual blade 26′ and the radially inner surface of the endplate 32 when the endplate 32 is correctly arranged adjacent to the casing 22 (see FIG. 13);
providing a semi-finished interface 36 having a radially inner end that defines a rest plane π and shaped to couple and connect continuously to the radially outer end of the extruded/pultruded profile of the blade 26;
cutting the radially outer end of the interface 36 along the intersection spatial curve 42;
constraining the radially outer end of the interface 36 to the radially inner surface of the endplate 32;
cutting the blade 26 along the rest plane π;
constraining the radially inner end of the interface 36 to the radially outer end of the aerodynamic portion 30 of the cut blade 26;
repeating the operations defined above for each blade 26.

As the person skilled in the art can well understand, the method of the invention can theoretically be carried out entirely with manual equipment, without the aid of computer tools. However, this purely manual approach necessarily requires the use of highly skilled labour and does not allow significant advantages to be obtained in terms of economies of scale. Therefore, it is preferable that at least some of the steps of the method are carried out with the aid of a computer system of CAD/CAM type (Computer-Aided Design/Computer-Aided Manufacturing).

As already mentioned above, in the present discussion the same term (for example “endplate”) can indifferently indicate a physical element in the real world (for example an aluminium sheet endplate) or its virtual representation in the space of descriptive geometry or in digital format (for example a CAD file representing the endplate). The person skilled in the art has no difficulty in correctly interpreting the meaning of such terms, depending on the context, and has no difficulty in transposing considerations and assessments from one scope of meaning to the other.

The step of identifying the airfoil may comprise the step of taking measurements on the blades 26 of the existing fan 20; for example, by proceeding manually, it is possible to take measurements graphically, by drawing the airfoil on a sheet. The manually drawn shape on the sheet can then be acquired in digital format. Preferably the measurements can be performed by three-dimensional scanning of the airfoil, for example employing a suitable laser technology known per se.

It is therefore preferable that in this step a virtual airfoil is generated in digital format, which allows to proceed with at least some of the subsequent steps of the method by computer.

Definitely easy is the step of identifying the geometric design parameters of the blades 26 of the rotor (i.e. the angle of attack α, precone angle β and swing angle γ) since these are macroscopically evident.

It is particularly advantageous to perform by computer the steps of defining the virtual blade 26′ of indefinite extension and of determining the spatial curve 42 representing the intersection of said virtual blade 26′ with the radially inner surface of the endplate 32 correctly positioned. In order to perform these operations manually, deep notions of stereometry and stereography and complex calculations are necessary.

By computer, on the other hand, it is sufficient to correctly position the endplate 32 and the virtual blade 26′. In particular, the endplate 32 must be positioned correctly with respect to the casing 22, so that the two cylinders (the one to which the radially inner surface of the casing 22 belongs and the one to which the radially outer surface of the endplate 32 belongs) are coaxial. The acquired airfoil must be correctly arranged with respect to the axis X, in particular in accordance with the geometric parameters identified.

Once the endplate 32 and the virtual blade 26′ are correctly positioned, it is sufficient to virtually extrude the airfoil along the longitudinal axis l of the virtual blade 26′ until the endplate 32 is passed through. In this case, if necessary, the endplate 32 can also be moved virtually in the axial direction and/or in the circumferential direction to obtain an optimal intersection with the virtual blade 26′.

Once the positions of the endplate 32 and the blade 26 are defined, the CAD program easily obtains the intersection spatial curve 42 as the place of the points belonging simultaneously to the outer surface of the virtual blade 26′ and to the radially inner surface of the endplate 32 (see FIG. 13).

Once the intersection spatial curve 42 has been defined, a semi-finished interface 36 must be provided which is suitable for obtaining the desired interface 36 (see FIG. 14). With reference to the correct orientation it will assume within the blade 26, the semi-finished interface 36 has a radially inner end and a predefined radial extension. The radially inner end defines a rest plane, intended to coincide in use with the plane π defined by the radially outer end of the aerodynamic portion 30. The radially inner end of the semi-finished interface 36 comprises means for the structural coupling with the radially outer end of the aerodynamic portion 30; such coupling means 40 have been described above.

The radial extension of the semi-finished interface 36 must be sufficiently extended in order to be able to contain all possible configurations of the intersection spatial curve 42, deriving from the different possible combinations of geometric design parameters. At the same time, the radial extension of the semi-finished interface 36 must be sufficiently reduced to allow it to be loaded into a numerically controlled machine (e.g. a CNC machining centre) for the desired interface 36 to be obtained. By way of example, the radial extension of the semi-finished interface 36 may be comprised within 20 cm, preferably within 10 cm.

The interface 36 may be made of aluminium (e.g. by die casting), polymer or composite material, preferably with short fibres (e.g. by moulding). In accordance with some embodiments, the interface 36 may comprise an extruded/pultruded profile segment identical to that employed for the construction of the aerodynamic portion 30 of the blade 26. In this case, the radially inner end must be cut so as to define a rest plane π and the means 40 for the structural coupling must be added.

Once the semi-finished interface 36 has been provided, it must be cut along the intersection spatial curve 42. To this end, although it is theoretically possible to proceed with manual equipment, it is certainly preferable to load the semi-finished interface 36 into a numerical control machine which is programmed and configured to perform the three-dimensional cutting following the intersection spatial curve 42.

Once the cutting step is completed, the radially outer surface of the interface 36 adheres perfectly to the radially inner surface of the endplate 32. Therefore it is possible to rest the interface 36 to the endplate 32 and constrain the two pieces together. This constraint step is particularly easy thanks to the precision of the rest obtained through the previous steps of the method.

By way of example, in the case where both parts are made of aluminium (for example the endplate 32 is a calendered sheet metal and the interface 36 is a die-cast profile) the union can take place by welding, for example by TIG (Tungsten Inert Gas) welding. Although the welding can also be performed by means of a numerical control machine, the simplicity of this operation also allows it to be carried out by hand, following the rest contour between the two pieces that winds up along the intersection spatial curve 42.

Alternatively, in the case where both pieces are made of composite material (for example the endplate 32 is a curved panel and the interface 36 is a moulded piece) the union can take place by gluing, for example with epoxy glue. The person skilled in the art will have no difficulty in selecting other methods of constraint between the endplate 32 and the interface 36, even if they are made of different materials.

The blade 26, and in particular its aerodynamic portion 30, must be cut along the rest plane π, preferably perpendicular to the longitudinal axis l of the blade 26. The position of said plane π along the longitudinal axis l of the blade 26 was preferably calculated in the previous steps, for example after the step of determining the intersection spatial curve 42. The rest plane π is defined in such a way that, once the endplate 32 is constrained to the interface 36 and the interface 36 is constrained to the aerodynamic portion 30, the endplate 32 is correctly positioned with respect to the casing 22.

As the person skilled in the art can well understand, the operations described above must be repeated for each of the blades 26 of the existing fan 20. Once all the blades 26 are finished, they can be assembled on the hub 24, so as to obtain a completely revamped fan 20 in accordance with the invention.

A second method of the invention is intended to make from the beginning a ducted fan 20 in accordance with the invention, as part of the total replacement of the fans 20 in an existing plant or as part of the construction of a totally new plant. This second method is therefore aimed at making an axial fan 20 comprising a hub 24 rotatable about an axis of rotation X, a plurality of blades 26 and a cylindrical casing 22 arranged around the hub 24 and coaxial therewith.

The second method of the invention comprises the steps of
defining the diameter of the casing 22
based on the diameter of the casing 22, defining an endplate 32, wherein the endplate 32:
   extends mainly in the axial direction and in the circumferential direction,
   defines a radially inner surface and a radially outer surface which is shaped according to a cylindrical surface portion,
   when the endplate 32 is correctly arranged adjacent to the casing 22, the radially outer surface defines with the casing 22 a gap 34 with uniform and constant thickness;
selecting the airfoil with which to make the aerodynamic portion 30 of the blades 26;
providing an extruded/pultruded profile having the airfoil selected above and an indefinite extension along its own longitudinal axis l perpendicular to the airfoil plane;
providing a root portion 28 at a radially inner end of the extruded or pultruded profile;
defining the geometric design parameters of the blades 26 of the rotor, i.e.: angle of attack α, precone angle β and swing angle γ;
defining a virtual blade 26′ having the airfoil selected above, the geometric design parameters defined above and an indefinite radial extension;
determining the spatial curve 42 representing the intersection between the virtual blade 26′ and the radially inner surface of the endplate 32 when the endplate 32 is correctly arranged adjacent to the casing 22;
providing an interface 36 having a radially inner end that defines a rest plane π and shaped to couple and connect continuously to the radially outer end of the extruded/pultruded profile of the blade 26;
cutting the radially outer end of the interface 36 along the intersection spatial curve 42;
constraining the radially outer end of the interface 36 to the radially inner surface of the endplate 32;
cutting the extruded/pultruded profile of the blade 26 along the rest plane π, so as to obtain the aerodynamic portion 30;
constraining the radially inner end of the interface 36 to the radially outer end of the aerodynamic portion 30;
constraining the root portion 28 of the blade 26 to the hub 24 according to the geometric design parameters;
repeating the operations defined above for each blade 26.

As the person skilled in the art can well understand, this second method is very similar to the first method, except that it comprises several preliminary design phases of the fan 20. In the first method such steps are not necessary because the method itself is aimed at keeping the fan 20 in the existing shape and at modifying only the tip of the blades 26 with the addition of the endplates 32. In this second method, instead, starting from the beginning, all the preliminary design phases are necessary, such as the definition of the diameter of the fan 20 and hence of the casing 22, the selection of the airfoil for the blades 26, the definition of the geometric parameters, etc. These phases are, moreover, well known to the person skilled in the art.

In light of the above, the person skilled in the art can well understand how the invention overcomes the drawbacks highlighted in relation to the prior art.

In particular, the provision of the interface 36 allows cutting along the intersection spatial curve 42 in a way that is both precise and easy. This cutting is in fact too complex to be carried out manually, and it therefore requires the use of a numerical control machine. However, the aerodynamic portions of the blades 26 usually have dimensions incompatible with the working chambers of common CNC machines. The interface 36, on the other hand, with much smaller dimensions, can be easily loaded into the working chamber of a very common numerical control machine.

In particular, the present invention makes available an axial fan that optimizes the geometry of the endplates at the tip of the blades.

Furthermore, the present invention makes available a ducted axial fan that optimizes the interaction between the endplates at the tip of the blades and the casing.

Moreover, the present invention makes available a method for improving the efficiency of an existing axial fan.

Finally, the present invention makes available a method for realizing an improved axial fan comprising optimized endplates at the ends of the blades.

In conclusion, all the details can be replaced by other technically equivalent elements; the characteristics described in relation to a specific embodiment can also be used in the other embodiments; the materials used, as well as the contingent shapes and dimensions, can be any according to the specific implementation needs without leaving the scope of protection of the following claims.

1-11. (canceled)

12. An axial fan comprising a rotor rotatable about an axis of rotation X and a cylindrical casing arranged about and coaxial with the rotor, wherein:
the rotor comprises a hub and a plurality of blades;
each blade comprises a radially inner root portion constrained to the hub, an aerodynamic portion that extends mainly in radial direction from the root portion outwardly, and an endplate at the radially outer end;
the aerodynamic portion is obtained from an extruded/pultruded profile;
the aerodynamic portion defines, in a cross section, an airfoil;
the endplate extends mainly in the axial direction and in the circumferential direction;
the endplate defines a radially inner surface and a radially outer surface which is shaped according to a cylindrical surface portion;
when the endplate is correctly arranged adjacent to the casing, the radially outer surface defines with the casing a gap with uniform and constant thickness, and wherein the blade further comprises an interface positioned between the aerodynamic portion and the endplate;
the interface is made structurally independent of the aerodynamic portion of the blade;
the radially outer end of the aerodynamic portion is defined by a plane π;
the radially outer end of the interface adheres continuously to the radially inner surface of the endplate;
the radially inner end of the interface is defined by the plane π;
the radially inner end of the interface is coupled and connected continuously to the aerodynamic portion; and
the radially inner end of the interface comprises means for structural coupling with the radially outer end of the aerodynamic portion.

13. The fan according to claim 12, wherein the thickness of the gap comprised between the endplate and the casing is less than or equal to 0.005 times the diameter of the fan.

14. The fan according to claim 12, wherein the interface is joined to the aerodynamic portion of the blade during the assembly of the fan.

15. The fan according to claim 12, wherein the endplate is obtained by at least a first panel, radially innermost, and a second panel, radially outermost, juxtaposed with each other in radial direction.

16. The fan according to claim 12, wherein the casing comprises an annular seat which extends circumferentially around the rotor and opens in the axial direction a, and wherein each of the endplates provided at the end of the blades is received at least partially in the annular seat.

17. The fan according to claim 12, wherein on the interface a baffle is provided which extends in the circumferential direction c and in the axial direction a, radially inside with respect to the endplate and with respect to the annular seat.

18. An industrial cooling system comprising a fan according to claim 12.

19. A method for modifying an existing axial fan comprising a hub rotatable about an axis of rotation X, a plurality of blades and a cylindrical casing arranged around the hub and coaxial therewith, wherein each blade comprises an aerodynamic portion obtained from an extruded/pultruded profile having its own longitudinal axis l and having a cross section, perpendicular to the longitudinal axis l, shaped according to an airfoil, and wherein the method comprises the steps of:
based on the diameter of the casing, defining an endplate, wherein the endplate:
extends in the axial direction and in the circumferential direction,
defines a radially inner surface and a radially outer surface which is shaped according to a cylindrical surface portion,
when the endplate is correctly arranged adjacent to the casing, the radially outer surface defines with the casing a gap with uniform and constant thickness;
identifying the airfoil with which the aerodynamic portion of the blades is made;
identifying the geometric design parameters of the blades of the rotor with an angle of attack α, precone angle β, and swing angle γ;
defining a virtual blade having the airfoil and the geometric design parameters identified above and an indefinite radial extension;
determining the spatial curve representing the intersection between the virtual blade and the radially inner surface of the endplate when the endplate is correctly arranged adjacent to the casing;
providing an interface having a radially inner end that defines a rest plane π and shaped to couple and connect continuously to the radially outer end of the extruded/pultruded profile of the blade;
cutting the radially outer end of the interface along the intersection spatial curve;
constraining the radially outer end of the interface to the radially inner surface of the endplate;
cutting the blade along the rest plane π;
constraining the radially inner end of the interface to the radially outer end of the aerodynamic portion of the cut blade; and
repeating the operations defined above for each blade.

20. The method according to claim 19, wherein at least some of the steps are carried out with the aid of a computer system of CAD/CAM type.

21. The method according to claim 19, wherein the step of cutting the radially outer end of the interface along the intersection spatial curve is carried out by a numerical control machine.

22. A method for making an axial fan comprising a hub rotatable about an axis of rotation X, a plurality of blades and a cylindrical casing arranged around the hub and coaxial therewith, wherein the method comprises the steps of:
defining the diameter of the casing;
based on the diameter of the casing, defining an endplate, wherein the endplate:
extends mainly in the axial direction and in the circumferential direction,
defines a radially inner surface and a radially outer surface which is shaped according to a cylindrical surface portion,
when the endplate is correctly arranged adjacent to the casing, the radially outer surface defines with the casing a gap with uniform and constant thickness;
selecting the airfoil with which to make the aerodynamic portion of the blades;
providing an extruded/pultruded profile having the airfoil selected above and an indefinite extension along its own longitudinal axis l perpendicular to the airfoil plane;
providing a root portion at a radially inner end of the extruded or pultruded profile;
defining the geometric design parameters of the blades of the rotor with an angle of attack α, precone angle β, and swing angle γ;
defining a virtual blade having the airfoil selected above, the geometric design parameters defined above and an indefinite radial extension;
determining the spatial curve representing the intersection between the virtual blade and the radially inner surface of the endplate when the endplate is correctly arranged adjacent to the casing;
providing an interface having a radially inner end that defines a rest plane π and shaped to couple and connect continuously to the radially outer end of the extruded/pultruded profile of the blade;
cutting the radially outer end of the interface along the intersection spatial curve;
constraining the radially outer end of the interface to the radially inner surface of the endplate;
cutting the extruded/pultruded profile of the blade along the rest plane π, so as to obtain the aerodynamic portion;
constraining the radially inner end of the interface to the radially outer end of the aerodynamic portion;
constraining the root portion of the blade to the hub according to the geometric design parameters; and
repeating the operations defined above for each blade.
